(19) United States
(12) Patent Application Publication
(10) Pub. No.: US 2026/0221123 A1
(43) Pub. Date: Jul. 30, 2026

(54) PAD FOR ELECTRONIC PERCUSSION INSTRUMENT AND ELECTRONIC CYMBAL PAD

(71) Applicant: HOSHINO GAKKI CO., LTD., Nagoya (JP)

(72) Inventor: Hideyuki MIYAJIMA, Nagoya (JP)

(21) Appl. No.: 19/266,099

(22) Filed: Jul. 10, 2025

(30) Foreign Application Priority Data
Jan. 24, 2025 (JP) 2025-010477

(51) Int. Cl. G10D 13/20

(52) U.S. Cl. CPC G10D 13/20

(57) ABSTRACT

A tom pad includes an impact receiving unit, a vibration plate, a case, a vibration sensor, and a first elastic member. A back surface of the impact receiving unit, opposite to an impact receiving surface, is formed by a vibration absorbing member. The vibration plate is in contact with the back surface. The vibration plate has smaller external dimensions than the back surface. The case supports the impact receiving unit and accommodates the vibration plate. The vibration sensor is disposed on the opposite side of the vibration plate from the impact receiving unit. The first elastic member presses the vibration sensor and the vibration plate toward the back surface.

### CROSS-REFERENCE TO RELATED APPLICATIONS

This application is based upon and claims the benefit of priority from Japanese Patent Application No. 2025-010477, filed on Jan. 24, 2025, the entire contents of which are incorporated herein by reference.

### BACKGROUND

### 1. Field

The present disclosure relates to a pad for an electronic percussion instrument and an electronic cymbal pad.

### 2. Description of Related Art

Japanese Laid-Open Patent Publication No. 2001-142459 discloses a head for an electronic percussion instrument including a tubular body, a sheet-shaped head member stretched under tension over the upper end of the body, and a vibration absorbing member that absorbs vibration of the head member. The head member includes an impact receiving surface that is struck by a player. The upper surface of the vibration absorbing member is in contact with the entire back surface of the head member, opposite to the impact receiving surface, within the body.

The head for an electronic percussion instrument further includes a support plate supporting the vibration absorbing member, a vibration detection sensor that detects vibration of the support plate, and an electronic tone generator that generates musical tones based on detection signals from the vibration detection sensor. The support plate supports the entire lower surface of the vibration absorbing member. The vibration detection sensor is disposed on the lower surface of the central portion of the support plate. The vibration detection sensor detects vibration of the support plate resulting from impacts to the head member and outputs detection signals to the electronic tone generator.

In the head for an electronic percussion instrument, contact between the upper surface of the vibration absorbing member and the entire back surface of the head member reduces striking noise from the head member. However, since the support plate supports the entire lower surface of the vibration absorbing member, vibration of the support plate is likely to be limited by the vibration absorbing member. Accordingly, vibrations of the head member may not be easily transmitted to the support plate via the vibration absorbing member. As a result, the detection accuracy of the vibration detection sensor may be reduced. Such reduction in the detection accuracy becomes more pronounced with weaker impacts to the head member. Accordingly, in electronic percussion instruments, there is a need to achieve both a reduction in striking noise and prevention of reduction in the detection accuracy of the vibration detection sensor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a pad for an electronic percussion instrument includes an impact receiving unit, a vibration plate, a case, a vibration sensor, and an elastic member. The impact receiving unit includes an impact receiving surface and a back surface opposite to the impact receiving surface. The back surface is formed of a vibration absorbing member that absorbs vibrations of the impact receiving surface. The vibration plate is in contact with the back surface and has external dimensions smaller than those of the back surface. The case supports the impact receiving unit and accommodates the vibration plate. The vibration sensor is disposed on a side opposite of the vibration plate from the impact receiving unit and detects vibrations of the vibration plate. The elastic member presses the vibration sensor and the vibration plate toward the back surface.

In another general aspect, an electronic cymbal pad includes an impact receiving unit, a case, and a vibration sensor. The impact receiving unit includes an impact receiving surface and a back surface opposite to the impact receiving surface. The back surface is formed of a vibration absorbing member that absorbs vibrations of the impact receiving surface. The case accommodates the impact receiving unit in a state in which the impact receiving surface is exposed to an outside. The vibration sensor detects vibrations of the impact receiving unit. The impact receiving unit includes a bow portion forming an upper surface of the electronic cymbal pad, and an edge portion forming an outer peripheral portion continuous with the upper surface of the electronic cymbal pad. The bow portion and the edge portion are exposed from the case.

Other features and aspects will be apparent from the following detailed description, the drawings, and the claims.

### BRIEF DESCRIPTION OF THE DRAWINGS

FIG. 1 is a perspective view of an electronic drum set.

FIG. 2 is an exploded perspective view of a tom pad according to a first embodiment.

FIG. 3 is an exploded perspective view of an impact receiving unit of FIG. 2.

FIG. 4 is a cross-sectional view of the tom pad shown in FIG. 1.

FIG. 5 is an exploded perspective view of a tom pad and a bracket shown in FIG. 1.

FIG. 6 is a cross-sectional view of a snare drum pad according to a second embodiment.

FIG. 7 is an exploded perspective view of a bass drum pad according to a third embodiment.

FIG. 8 is an exploded perspective view of an impact receiving unit of FIG. 7.

FIG. 9 is a cross-sectional view of the bass drum pad shown in FIG. 7.

FIG. 10 is an exploded perspective view of a cymbal pad according to a fourth embodiment.

FIG. 11 is an exploded perspective view of an impact receiving unit of FIG. 10.

FIG. 12 is a cross-sectional view of the cymbal pad shown in FIG. 10.

FIG. 13 is a cross-sectional view taken along line 13A-13A of FIG. 12.

FIG. 14 is a bottom view of the cymbal pad shown in FIG. 10.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

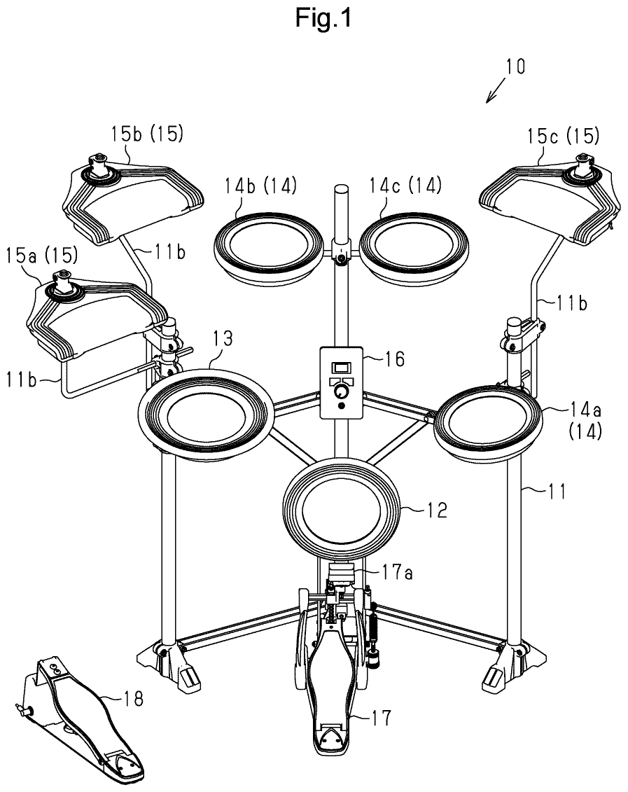

Hereinafter, a pad for an electronic percussion instrument according to a first embodiment will be described with reference to FIGS. 1 to 5. In the first embodiment, the pad is employed as a tom pad in an electronic drum set 10.

As shown in FIG. 1, the electronic drum set 10 includes a stand 11, a bass drum pad 12, a snare drum pad 13, a floor tom pad 14a, a first tom pad 14b, a second tom pad 14c, a hi-hat cymbal pad 15a, a first cymbal pad 15b, and a second cymbal pad 15c. Each pad is connected to the stand 11 via various connecting members.

The electronic drum set 10 includes a sound source device 16, which produces sounds based on the output signals of vibration sensors provided on the pads. The sound source device 16 is attached to the stand 11. The sound source device 16 is connected to the vibration sensors of the pads by cables (not shown).

The pads other than the bass drum pad 12 are played by the player by striking them with a drumstick (not shown). The bass drum pad 12 is played with a pedal device 17 including a beater 17a, which swings in response to a stepping operation by the player. The hi-hat cymbal pad 15a produces a different tone when being struck depending on the presence or absence of a stepping operation of a hi-hat pedal 18 by the player.

The floor tom pad 14a, the first tom pad 14b, and the second tom pad 14c have the same configuration. In the following description, the floor tom pad 14a, the first tom pad 14b, and the second tom pad 14c are collectively referred to as tom pad 14.

### Overall Configuration of Tom Pad 14

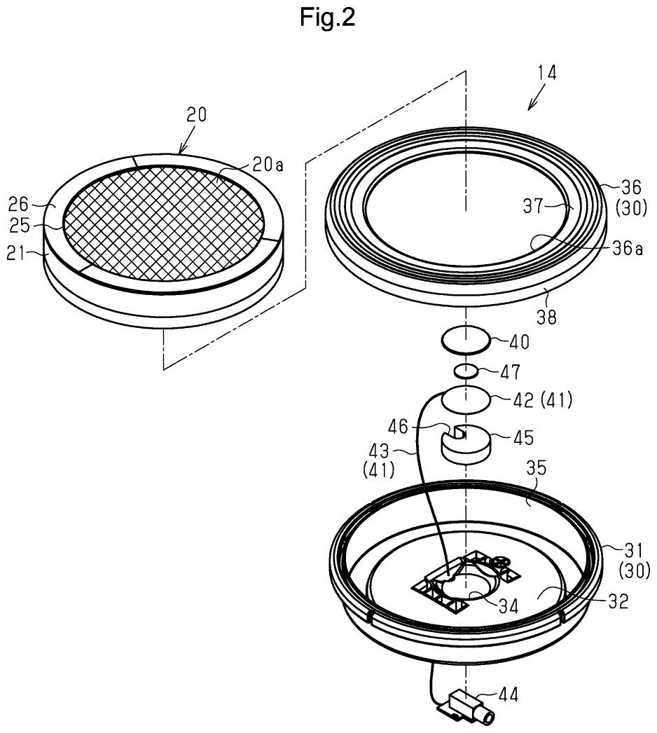

As shown in FIG. 2, the tom pad 14 includes an impact receiving unit 20, a case 30, a vibration plate 40, a vibration sensor 41, a first elastic member 45, and a second elastic member 47.

### Configuration of Impact Receiving Unit 20

The impact receiving unit 20 has an impact receiving surface 20a that is struck by drumsticks. The impact receiving unit 20 includes a vibration absorbing member 21, a sheet 25 covering a surface of the vibration absorbing member 21, and a cushioning member 26 covering an outer peripheral portion of the surface of the sheet 25. The sheet 25 forms the impact receiving surface 20a. The vibration absorbing member 21 absorbs vibrations of the impact receiving surface 20a.

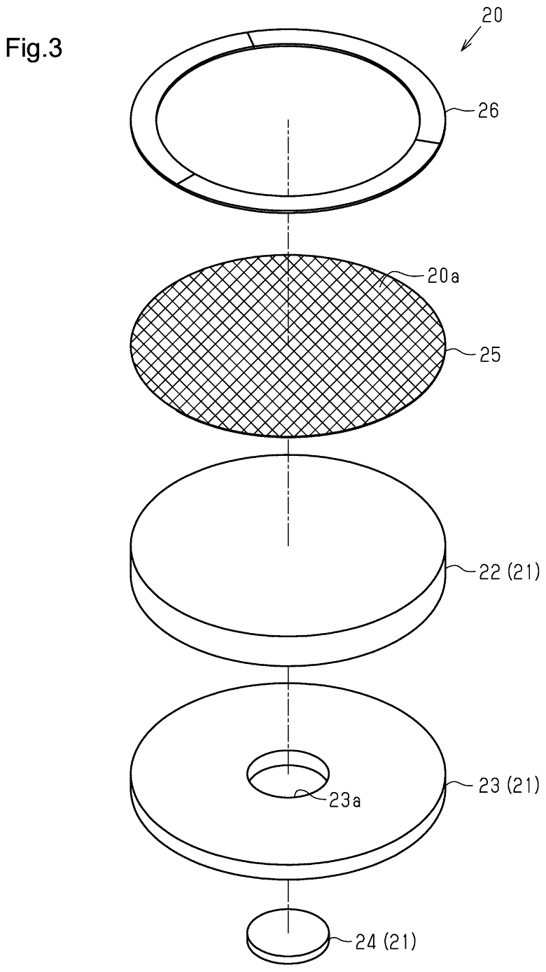

As shown in FIG. 3, the vibration absorbing member 21 includes a first sponge 22, a second sponge 23, and a third sponge 24. The first sponge 22 is a hard sponge. The second sponge 23 and the third sponge 24 are soft sponges.

The first sponge 22, the second sponge 23, and the third sponge 24 are all disc-shaped. The diameter of the second sponge 23 is substantially the same as the diameter of the first sponge 22. The second sponge 23 is bonded to the lower surface of the first sponge 22 using an adhesive (not shown). The second sponge 23 includes a circular center hole 23a extending through the second sponge 23 in a thickness direction. The diameter of the third sponge 24 is substantially the same as the diameter of the center holes 23a.

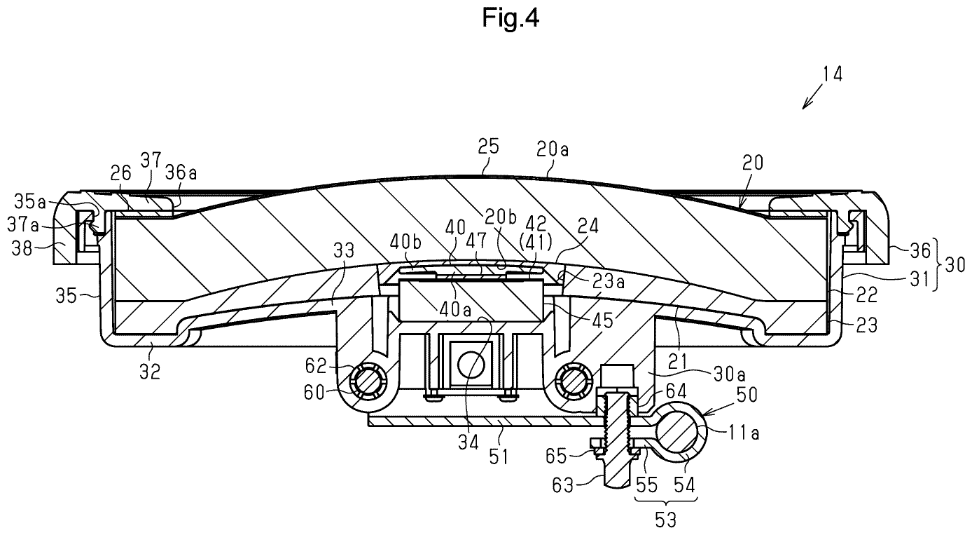

As shown in FIG. 4, the third sponge 24 is accommodated in the center hole 23a and is bonded to the lower surface of the first sponge 22 using an adhesive (not shown). In the impact receiving unit 20, a back surface 20b, on a side opposite to the impact receiving surface 20a, is formed by the second sponge 23 and the third sponge 24.

As shown in FIG. 3, the sheet 25 has a circular shape having substantially the same diameter as the diameter of the first sponge 22. The sheet 25 covers the surface of the vibration absorbing member 21; more specifically, the surface of the first sponge 22. The sheet 25 is a flexible mesh material. The sheet 25 is formed of, for example, a resin material. An outer peripheral portion of the sheet 25 is bonded to the outer peripheral portion of the surface of the first sponge 22 using an adhesive (not shown). In other words, the vibration absorbing member 21 and the sheet 25 are integrated. In the present embodiment, only the outer peripheral portion of the sheet 25 is bonded to the first sponge 22.

The cushioning member 26 has an annular shape having substantially the same diameter as the diameter of the sheet 25. The cushioning member 26 is formed by circularly arranging multiple felt members that extend in arcuate shapes. The cushioning member 26 is bonded to the outer peripheral portion of the surface of the sheet 25 using an adhesive (not shown). In other words, the vibration absorbing member 21, the sheet 25, and the cushioning member 26 are integrated. The cushioning member 26 prevents generation of contact noises between the sheet 25 and a cover 36, which will be described later, when the impact receiving unit 20 is struck.

### Structure of the Case 30

As shown in FIG. 2, the case 30 accommodates the impact receiving unit 20 in a state in which the impact receiving surface 20a is exposed to the outside. In other words, the case 30 supports the impact receiving unit 20.

The case 30 includes a case body 31 and a cover 36 attached to the case body 31. The case body 31 is formed of, for example, a hard resin material. The cover 36 is formed of, for example, a soft resin material. The cover 36 has flexibility.

The case body 31 accommodates the impact receiving unit 20, the vibration plate 40, the vibration sensor 41, the first elastic member 45, and the second elastic member 47. The case body 31 includes a bottom wall 32 having a circular shape in plan view, and an annular case peripheral wall 35 protruding from an outer peripheral edge of the bottom wall 32.

As shown in FIG. 4, the bottom wall 32 includes a dome-shaped curved portion 33. The curved portion 33 is shaped such that its displacement in the protruding direction of the case peripheral wall 35 increases toward a central region of the bottom wall 32. An accommodating recess 34 recessed in a direction opposite to the protruding direction of the case peripheral wall 35 is provided in a central portion of the curved portion 33.

The bottom wall 32 includes an attachment portion 30a, which protrudes downward and to which a bracket 50 described later is attached.

The case peripheral wall 35 is provided with multiple engaging holes 35a at intervals in the circumferential direction.

The cover 36 includes an annular retaining portion 37 and an annular cover peripheral wall 38 protruding from the outer peripheral edge of the retaining portion 37. The retaining portion 37 covers the protruding end face of the case peripheral wall 35 and projects radially inward in the case body 31 beyond the case peripheral wall 35. The cover peripheral wall 38 covers the outer circumferential surface of the case peripheral wall 35. The retaining portion 37 presses the cushioning member 26, which forms the outer peripheral portion of the impact receiving unit 20, from the side opposite to the bottom wall 32. The retaining portion 37 forms an opening 36a for exposing the impact receiving surface 20a.

The retaining portion 37 is provided with multiple engaging tabs 37a, which are respectively engaged with the engaging holes 35a of the case peripheral wall 35. The cover 36 is attached to the case body 31 by engaging the engaging tabs 37a with the engaging holes 35a.

The impact receiving unit 20 is accommodated in the case 30 in a state in which it conforms to the curved portion 33 of the bottom wall 32 and is held along its entire circumference by the retaining portion 37 at its outer peripheral portion. Accordingly, the impact receiving unit 20 is accommodated in the case 30 in a curved state in which a central portion of the impact receiving surface 20a protrudes relative to other portions. The central portion of the impact receiving unit 20 protrudes beyond the retaining portion 37 to the outside of the case 30. In the state in which the impact receiving unit 20 is accommodated in the case 30, the second sponge 23 and the third sponge 24, which are soft sponges, are deformed in the thickness direction. In contrast, the first sponge 22, which is a hard sponge, is substantially undeformed in the thickness direction.

As will be described later, the vibration plate 40, vibrations of which are detected by the vibration sensor 41, is in contact with the third sponge 24 without being fixed to the third sponge 24. In order to improve the detection accuracy of the vibration sensor 41, the vibration absorbing member 21 may be formed by only the first sponge 22, which is a hard sponge, and the vibration plate 40 be brought into contact with the first sponge 22. However, when the vibration absorbing member 21 is formed only by the first sponge 22, the striking noise generated at the impact receiving unit 20 may increase, or the contact noise between the first sponge 22 and the case 30 or the vibration plate 40 may increase. In order to suppress such drawbacks, the present embodiment includes the second sponge 23 and the third sponge 24 interposed between the first sponge 22 and the bottom wall 32 of the case body 31. Additionally, to facilitate vibration of the vibration plate 40, the thickness of the third sponge 24, which is in contact with the vibration plate 40, is set to be smaller than the thickness of the second sponge 23.

### Configuration of the Vibration Plate 40

The vibration plate 40 has a disc-shaped base 40a and a large-diameter portion 40b, which has a larger diameter than the base 40a. The vibration plate 40 is formed of, for example, a resin material. The vibration plate 40 is not in contact with the case 30. The vibration plate 40 is in contact with the back surface 20b of the impact receiving unit 20, which is formed by the second sponge 23 and the third sponge 24. Specifically, the large-diameter portion 40b is in contact with only the third sponge 24, which forms the back surface 20b, without being fixed to the third sponge 24. The upper surface of the large-diameter portion 40b is curved into a dome shape along the back surface 20b such that its upward displacement increases toward a central region of the large-diameter portion 40b. As a result, the large-diameter portion 40b is likely to be in uniform contact with the third sponge 24.

The vibration plate 40 has smaller external dimensions than the back surface 20b of the impact receiving unit 20. Specifically, the diameter of the large-diameter portion 40b is smaller than the diameter of the third sponge 24.

The thickness of the vibration plate 40 is set such that the vibration plate 40 is unlikely to undergo plastic deformation when the impact receiving unit 20 is struck.

### Configuration of the Vibration Sensor 41

As shown in FIG. 2, the vibration sensor 41 includes a flat detecting portion 42 for detecting vibrations of the vibration plate 40, and a cable 43 connected to the detecting portion 42. The vibration sensor 41 detects vibration of the detecting portion 42 transmitted from the vibration plate 40 and outputs a signal corresponding to the magnitude of the vibration to the sound source device 16.

The detecting portion 42 is disposed on the opposite side of the vibration plate 40 from the impact receiving unit 20. The detecting portion 42 is, for example, a disc-shaped piezoelectric element. The diameter of the detecting portion 42 is the same size as the diameter of the large-diameter portion 40b of the vibration plate 40. The thickness of the detecting portion 42 is smaller than the thickness of the vibration plate 40. The thickness of the detecting portion 42 is set to a value that allows the detecting portion 42 to vibrate easily when vibration is transmitted from the vibration plate 40.

The cable 43 extends through the bottom wall 32 and extends to the outside of the case 30. A jack 44 to which a plug (not shown) extending from the sound source device 16 is connected is provided at the distal end of the cable 43. The jack 44 is fixed to the lower surface of the case 30.

### Configuration of the First Elastic Member 45

As shown in FIG. 4, the first elastic member 45 is disposed on the opposite side of the detecting portion 42 from the impact receiving unit 20. The first elastic member 45 is formed of, for example, a hard sponge. The first elastic member 45 is accommodated in the accommodating recess 34. The first elastic member 45 is bonded to the bottom surface of the accommodating recess 34 and the detecting portion 42 using an adhesive (not shown). The first elastic member 45 presses the detecting portion 42 and the vibration plate 40 toward the back surface 20b of the impact receiving unit 20; more specifically, toward the third sponge 24. Accordingly, the third sponge 24 is compressed by the vibration plate 40.

The first elastic member 45 is disc-shaped. The diameter of the first elastic member 45 is the same as the diameter of the detecting portion 42. The thickness of the first elastic member 45 is set such that the first elastic member 45 presses the detecting portion 42 and the vibration plate 40 toward the back surface 20b when the impact receiving unit 20 is accommodated in the case 30.

As shown in FIG. 2, the first elastic member 45 includes a relief portion 46 for receiving the cable 43 of the vibration sensor 41. The relief portion 46 is formed by cutting out part of an outer peripheral region of the first elastic member 45.

### Configuration of the Second Elastic Member 47

As shown in FIG. 4, the second elastic member 47 is disposed between the vibration plate 40 and the vibration sensor 41. Specifically, the second elastic member 47 is bonded to the base 40a of the vibration plate 40 and the detecting portion 42 using an adhesive (not shown). The second elastic member 47 is formed of, for example, a soft sponge.

The second elastic member 47 is disc-shaped. The diameter of the second elastic member 47 is equal to the diameter of the base 40a of the vibration plate 40 and is smaller than the diameters of the large-diameter portion 40b of the vibration plate 40 and the detecting portion 42. The thickness of the second elastic member 47 is larger than the thickness of the detecting portion 42 and smaller than the thickness of the vibration plate 40 and the thickness of the first elastic member 45.

### Configuration of the Bracket 50

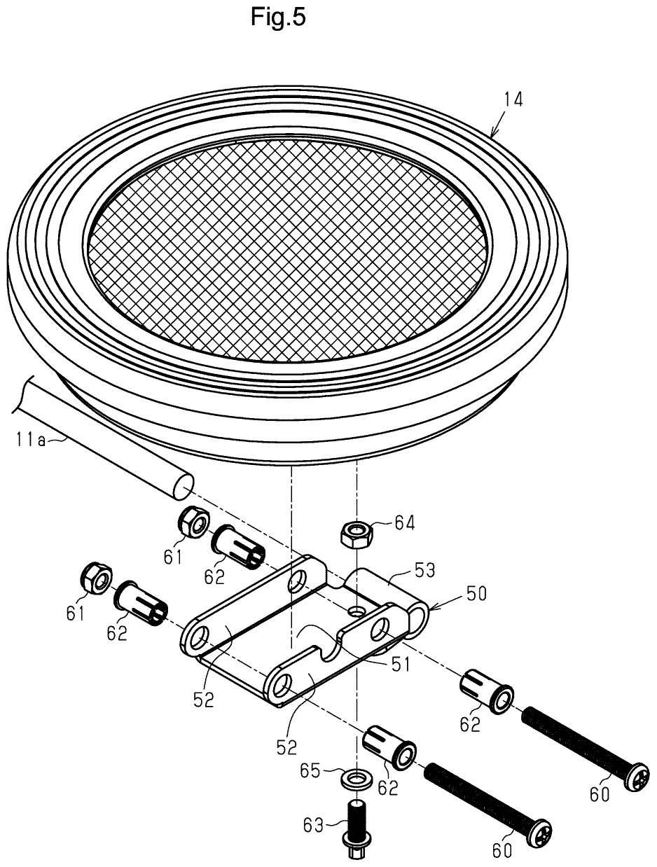

As shown in FIG. 5, the tom pad 14 is connected to a support rod 11a attached to the stand 11 via the bracket 50. The bracket 50 includes a bottom portion 51, two fixing portions 52, and a holding portion 53. The bottom portion 51 has the shape of a flat plate. The bottom portion 51 has a rectangular shape having long sides and short sides in plan view. The two fixing portions 52 protrude upward from the opposite ends of the bottom portion 51 in the short-side direction and face each other in the short-side direction. Each fixing portion 52 has the shape of a flat plate extending in the long-side direction of the bottom portion 51.

The two fixing portions 52 are arranged in the long-side direction of the bottom portion 51 and are fixed to the attachment portion 30a by two bolts 60 extending through the two fixing portions 52 and the attachment portion 30a (see FIG. 4) and two nuts 61 attached to the two bolts 60. Each bolt 60 extends through the two fixing portions 52 and is inserted into two cylindrical collars 62 inserted into the attachment portion 30a. In other words, the two collars 62 are interposed between the bolts 60 and the bracket 50.

The bolts 60 are formed of a metal material. The collars 62 are formed of a resin material. The collars 62 prevent generation of contact noise between the bolts 60 and the bracket 50.

As shown in FIG. 4, the holding portion 53 is provided at one end of the bottom portion 51 in the long-side direction. The holding portion 53 includes a cylindrical portion 54, into which the support rod 11a is inserted, and a flat plate-shaped support portion 55 extending from the cylindrical portion 54. The cylindrical portion 54 extends in the short-side direction of the bottom portion 51. A slit is formed along the entire axial length of the cylindrical portion 54. One end of the cylindrical portion 54 in the circumferential direction is continuous with one end of the bottom portion 51 in the long-side direction. The support portion 55 extends along the bottom portion 51 from the other end portion of the cylindrical portion 54 in the circumferential direction.

The holding portion 53 is configured such that a bolt 63, which extends through the support portion 55 and the bottom portion 51, is threaded into a nut 64 embedded in the attachment portion 30a, so that the support rod 11a inserted into the cylindrical portion 54 is fastened. A washer 65 is provided between the bolt 63 and the support portion 55.

### Operation of the Present Embodiment

With the tom pad 14 of the present embodiment, since the impact receiving unit 20 includes the vibration absorbing member 21, the striking noise of the impact receiving surface 20a is reduced. Additionally, since vibration generated by striking the impact receiving unit 20 is unlikely to be transmitted to the case 30, it is possible to prevent activation of vibration sensors in other pads due to transmission of the vibration through the stand 11.

The outer dimensions of the vibration plate 40 are smaller than the external dimensions of the back surface 20b of the impact receiving unit 20. Therefore, since the contact area between the vibration plate 40 and the vibration absorbing member 21 is minimized, the vibration plate 40 readily vibrates. As a result, the vibration sensor 41 readily detects vibration of the vibration plate 40.

Furthermore, the first elastic member 45 presses the vibration sensor 41 and the vibration plate 40 toward the back surface 20b of the impact receiving unit 20. Consequently, even when the vibration of the vibration absorbing member 21 caused by striking the impact receiving surface 20a is small, the vibration is more likely to be transmitted to the vibration plate 40. Additionally, even when vibration caused by striking another pad is transmitted to the tom pad 14, such vibration is absorbed by the first elastic member 45. This prevents the vibration from being transmitted to the vibration plate 40 and the vibration sensor 41. As a result, even when the vibration transmitted to the vibration plate 40 due to striking of the impact receiving surface 20a is small, the vibration sensor 41 is capable of detecting the vibration as vibration of the tom pad 14, while distinguishing it from vibrations of other pads.

### Advantages of the Present Embodiment

(1-1) The tom pad 14 includes the impact receiving unit 20, the vibration plate 40, the case 30, the vibration sensor 41, and the first elastic member 45. The back surface 20b of the impact receiving unit 20, opposite to the impact receiving surface 20a, is formed by the vibration absorbing member 21. The vibration plate 40 is in contact with the back surface 20b. The vibration plate 40 has smaller external dimensions than the back surface 20b. The case 30 supports the impact receiving unit 20 and accommodates the vibration plate 40. The vibration sensor 41 is disposed on the opposite side of the vibration plate 40 from the impact receiving unit 20. The first elastic member 45 presses the vibration sensor 41 and the vibration plate 40 toward the back surface 20b.

The above-described configuration achieves the operation described previously. The vibration caused by striking the impact receiving surface 20a is absorbed by the vibration absorbing member 21, thereby reducing striking noise, while enabling the vibration to be suitably transmitted to the vibration plate 40. Accordingly, it is possible to achieve both reduction of striking noise and prevention of reduction in the detection accuracy of the vibration sensor 41.
(1-2) The case 30 accommodates the impact receiving unit 20 in a state in which the impact receiving surface 20a is exposed to the outside.

With this configuration, since the impact receiving unit 20 is accommodated in the case 30, the impact receiving unit 20 is protected.
(1-3) The vibration plate 40 is in contact with the back surface 20b without being fixed to the back surface 20b.

With this configuration, the vibration plate 40 is in contact with the back surface 20b of the impact receiving unit 20 formed by the vibration absorbing member 21 without being fixed to the back surface 20b. Therefore, compared to a case in which the vibration plate 40 is fixed to the back surface 20b of the impact receiving unit 20, the vibration of the vibration plate 40 is less likely to be hindered by the vibration absorbing member 21.

Further, the vibration plate 40 is pressed against the back surface 20b of the impact receiving unit 20 by the first elastic member 45 without being fixed to the back surface 20b. Thus, even when vibration of the vibration absorbing member 21 caused by the striking of the impact receiving surface 20a is small, the elasticity of the first elastic member 45 facilitates vibration of the vibration plate 40.
(1-4) The diameter of the vibration plate 40 is the same as the diameter of the detecting portion 42.

With this configuration, the vibration plate 40 covers the entire surface of the detecting portion 42. As a result, when the vibration absorbing member 21 is deformed by striking the impact receiving surface 20a, the vibration absorbing member 21 and the vibration sensor 41 are prevented from contacting each other.
(1-5) The second elastic member 47 is disposed between the vibration plate 40 and the detecting portion 42.

With this configuration, since the second elastic member 47 is interposed between the vibration plate 40 and the detecting portion 42, the vibration of the vibration plate 40 is less likely to be limited by the detecting portion 42, as compared to a case in which the vibration plate 40 is fixed to the detecting portion 42. Thus, vibration caused by striking the impact receiving surface 20a is readily transmitted to the vibration plate 40 via the vibration absorbing member 21. Therefore, it is possible to suppress reduction in the detection accuracy of the vibration sensor 41.
(1-6) The diameter of the second elastic member 47 is smaller than the diameter of the vibration plate 40.

This configuration limits an increase in the contact area between the vibration plate 40 and the second elastic member 47, so that the vibration of the vibration plate 40 is less likely to attenuate. Therefore, it is possible to suppress reduction in the detection accuracy of the vibration sensor 41.

In addition, since the contact area between the vibration plate 40 and the second elastic member 47 is changed by changing the external dimensions of the second elastic member 47, the detection accuracy of the vibration sensor 41 can be adjusted.
(1-7) The impact receiving unit 20 includes the sheet 25, which forms the impact receiving surface 20a and covers the surface of the vibration absorbing member 21.

With this configuration, since the surface of the vibration absorbing member 21 is protected by the sheet 25, it is possible to limit deterioration of the vibration absorbing members 21 due to striking of the impact receiving surface 20a.
(1-8) The sheet 25 is a mesh material.

With this configuration, since the sheet 25 is a mesh material, the vibration at the time of striking the impact receiving surface 20a is less likely to be transmitted to the surrounding air. Thus, the striking noise of the impact receiving surface 20a is reduced as compared with a case in which the sheet 25 does not have holes extending through the sheet 25.
(1-9) The vibration absorbing member 21 and the sheet 25 are integrated.

This configuration suppresses the formation of a gap between the sheet 25 and the vibration absorbing member 21 caused by wrinkling of the sheet 25 resulting from striking the impact receiving surface 20a. Therefore, it is possible to suppress an increase in striking noise of the impact receiving surface 20a that would otherwise result from the presence of such a gap.

Additionally, when only a peripheral portion of the sheet 25 is bonded to the first sponge 22 using an adhesive, it is possible to prevent the exposure of the adhesive on the surface of the sheet 25 through the mesh openings.
(1-10) The impact receiving unit 20 is accommodated in the case 30 in a curved state in which a central portion of the impact receiving surface 20a protrudes relative to other portions.

With this configuration, the sheet 25 is stretched along the surface of the vibration absorbing member 21. As a result, the sheet 25 and the vibration absorbing member 21 readily come into close contact with each other, and thus it is possible to prevent the formation of a gap between the sheet 25 and the vibration absorbing member 21. Therefore, it is possible to suppress an increase in striking noise of the impact receiving surface 20a that would otherwise result from the presence of such a gap.
(1-11) The cover 36 has flexibility. The cover 36 includes the retaining portion 37, which forms the opening 36a for exposing the impact receiving surface 20a and presses the outer peripheral portion of the impact receiving unit 20.

With this configuration, the outer peripheral portion of the impact receiving unit 20 is held by the retaining portion 37. This prevents the impact receiving unit 20 from becoming dislodged from the case 30 through the opening 36a of the cover 36. Further, since the cover 36 has flexibility, the impact receiving unit 20 can be attached to and detached from the case 30 through the opening 36a of the cover 36 by deforming the cover 36 and the impact receiving unit 20 even in a state in which the cover 36 is attached to the case body 31. This facilitates replacement of the impact receiving unit 20.

### Second Embodiment

A pad for an electronic percussion instrument according to a second embodiment will now be described. In the present embodiment, the pad is used as the snare drum pad 13.

In the second embodiment, the same reference numerals are given to those components that are the same as those in the first embodiment. Also, reference numerals 1**, which are obtained by adding 100 to the reference numerals ** in the first embodiment, are given to the corresponding components, and redundant explanations are omitted.

### Configuration of the Snare Drum Pad 13

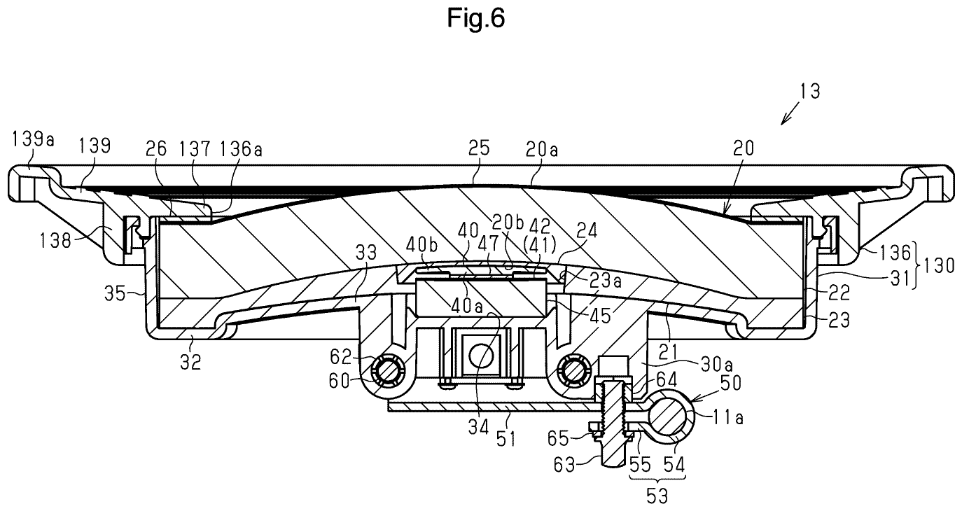

As shown in FIG. 6, the snare drum pad 13 includes an impact receiving unit 20, a case 130, a vibration plate 40, a vibration sensor 41, a first elastic member 45, and a second elastic member 47.

The case 130 includes a case body 31 and a cover 136 attached to the case body 31. The cover 136 includes, in addition to a retaining portion 137 and a cover peripheral wall 138, a flange portion 139 extending radially outward from the cover peripheral wall 138. The flange portion 139 is provided over the entire circumference of the cover 136.

The flange portion 139 is provided with an annular protrusion 139a that surrounds an opening 136a formed by the retaining portion 137. The top surface of the protrusion 139a is flat.

A central portion of the impact receiving unit 20 protrudes beyond the opening 136a, but does not protrude beyond the protrusion 139a. In other words, the central portion of the impact receiving unit 20 is located between the retaining portion 137 and the protrusion 139a in the protruding direction of the central portion.

### Advantages of the Present Embodiment

In addition to the advantages (1-1) to (1-11) of the first embodiment, the snare drum pad 13 according to the present embodiment achieves the following advantage.
(2-1) The cover 136 includes the annular protrusion 139a surrounding the opening 136a.

This configuration allows the player to perform a rimshot-style stroke, in which the impact receiving surface 20a and the protrusion 139a are struck simultaneously.

### Third Embodiment

A pad for an electronic percussion instrument according to a third embodiment will now be described. In the present embodiment, the pad is used as the bass drum pad 12.

In the third embodiment, the same reference numerals are given to those components that are the same as those in the first embodiment. Also, reference numerals 2**, which are obtained by adding 200 to the reference numerals ** in the first embodiment, are given to the corresponding components, and redundant explanations are omitted.

### Configuration of the Bass Drum Pad 12

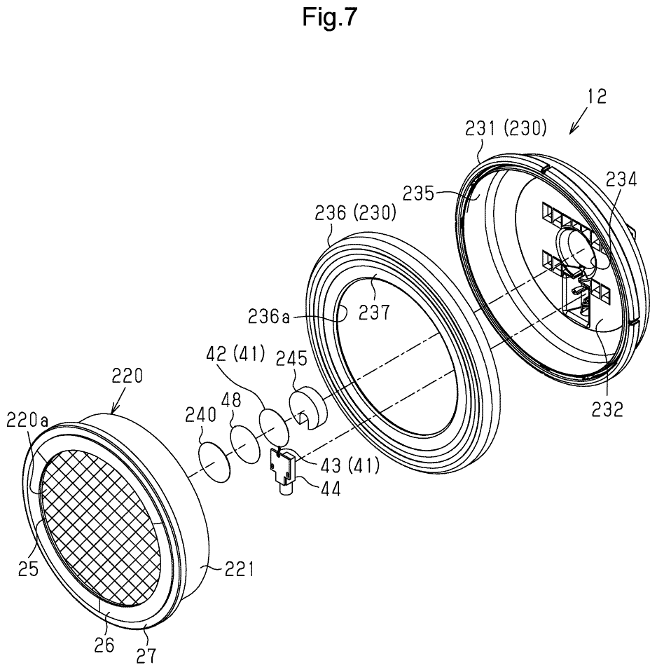

As shown in FIG. 7, the bass drum pad 12 includes an impact receiving unit 220, a case 230, a vibration plate 40, a vibration sensor 41, a double-sided tape 48, and an elastic member 245.

### Configuration of the Impact Receiving Unit 220

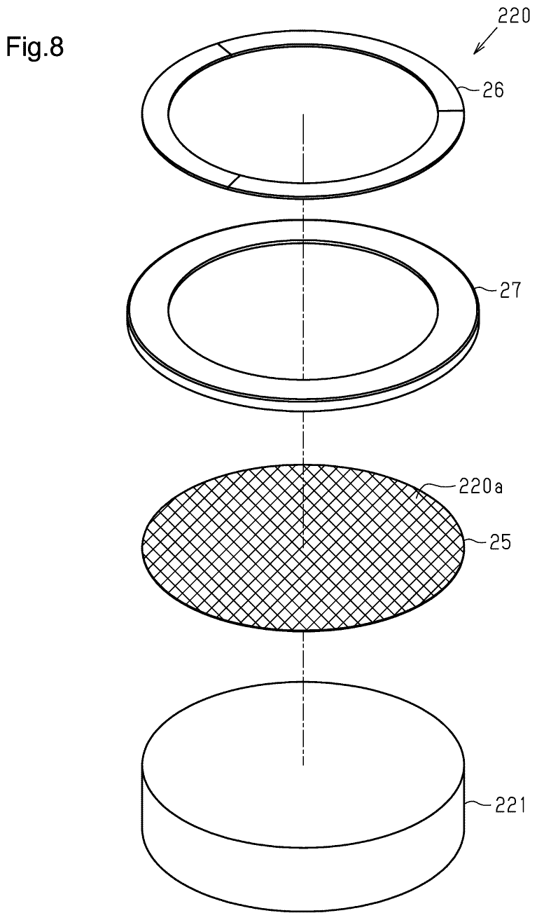

As shown in FIG. 8, the impact receiving unit 220 includes a vibration absorbing member 221, a sheet 25 covering the surface of the vibration absorbing member 221, a restraining member 27 covering the outer peripheral portion of the surface of the sheet 25, and a cushioning member 26 covering the surface of the restraining member 27.

The vibration absorbing member 221 is a soft sponge. The vibration absorbing member 221 is disc-shaped. In the bass drum pad 12, in which the impact receiving surface 220a is subjected to strong impacts by the beater 17a, the striking noise is readily reduced by the vibration absorbing member 221, which is a soft sponge.

The sheet 25 has a circular shape having substantially the same diameter as the diameter of the vibration absorbing member 221. The outer peripheral portion of the sheet 25 is bonded to the outer peripheral portion of the surface of the vibration absorbing member 221 using an adhesive (not shown).

The restraining member 27 has a lower flexibility than the vibration absorbing member 221. The restraining member 27 is formed of, for example, a soft resin material. The restraining member 27 has an annular shape. The diameter of the restraining member 27 is larger than the diameter of the vibration absorbing member 221. The thickness of the restraining member 27 is smaller than the thickness of the vibration absorbing member 221. The restraining member 27 is fixed to the outer peripheral portion of the impact receiving surface 220a. Specifically, the restraining member 27 is bonded to the outer peripheral portion of the surface of the sheet 25 using an adhesive (not shown).

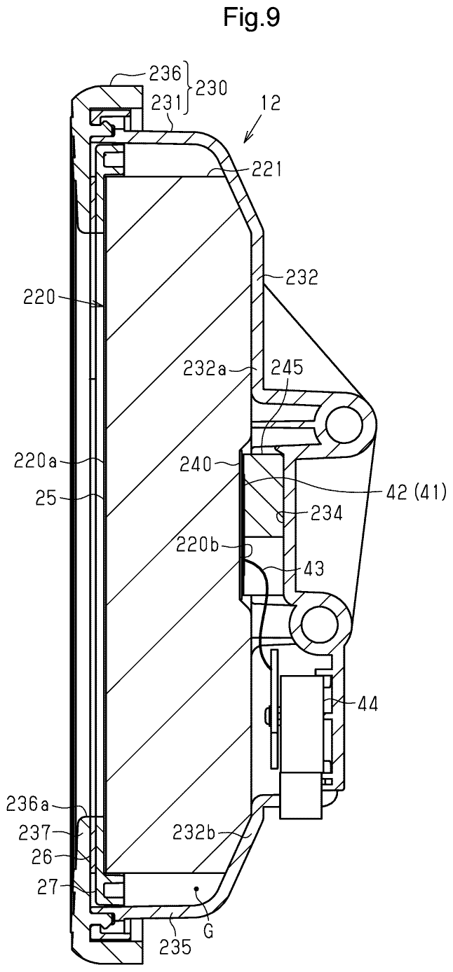

As shown in FIG. 9, the outer peripheral portion of the restraining member 27 protrudes in the axial direction more than other portions over the entire circumference, and covers the outer circumferential surface of the vibration absorbing member 221.

The cushioning member 26 is bonded to the inner peripheral portion of the surface of the restraining member 27 using an adhesive (not shown). In other words, the vibration absorbing member 221, the sheet 25, the restraining member 27, and the cushioning member 26 are integrated.

### Configuration of the Case 230

The case 230 includes a case body 231 and a cover 236 attached to the case body 231. A bottom wall 232 of the case body 231 includes a flat portion 232a, in which an accommodating recess 234 is provided, and a tapered portion 232b provided in an outer peripheral portion of the flat portion 232a. The tapered portion 232b connects the flat portion 232a and the case peripheral wall 235 to each other. The position of the vibration absorbing member 221 relative to the case body 231 is defined by undergoing elastic deformation along the tapered portion 232b.

A gap G is provided between an outer circumferential surface of the vibration absorbing member 221 and an inner circumferential surface of the case peripheral wall 235, extending circumferentially around the entire vibration absorbing member 221. An outer peripheral portion of the restraining member 27, which covers the outer circumferential surface of the vibration absorbing member 221, is disposed within the gap G. The amount of deformation of the impact receiving unit 220 tends to be relatively large in the bass drum pad 12, in which the impact receiving surface 220a is subjected to strong impacts by the beater 17a. The gap G is a space that allows the restraining member 27 to move toward the bottom wall 232 when the impact receiving unit 220 is deformed in response to striking the impact receiving surface 220a.

The retaining portion 237 presses the outer peripheral portion of the impact receiving unit 220 over the entire circumference. Accordingly, the restraining member 27 is held by the retaining portion 237 via the cushioning member 26.

The impact receiving unit 220 is accommodated in the case 230 in a state in which it conforms to the flat portion 232a of the bottom wall 232 and is held along its entire circumference by the retaining portion 237 at its outer peripheral portion. The impact receiving surface 220a of the impact receiving unit 220 accommodated in the case 230 is flat.

### Configuration of the Vibration Plate 240, the Vibration Sensor 41, and the Elastic Member 245

As shown in FIG. 7, the vibration plate 240 has the shape of a disc having a uniform thickness. The vibration plate 240 is formed of, for example, a metal material.

The vibration plate 240 and the detecting portion 42 of the vibration sensor 41 are bonded to each other via the double-sided tape 48.

The elastic member 245 has the same configuration as the first elastic member 45 of the first embodiment. The elastic member 245 is accommodated in the accommodating recess 234. The elastic member 245 is bonded to the bottom surface of the accommodating recess 234 and the detecting portion 42 using an adhesive (not shown). As shown in FIG. 9, the elastic member 245 presses the detecting portion 42 and the vibration plate 240 toward the back surface 220b of the vibration absorbing member 221. Accordingly, the vibration absorbing member 221 is compressed by the vibration plate 240.

### Operation of the Present Embodiment

In the bass drum pad 12, in which the impact receiving surface 220a is subjected to high-impact striking, if, for example, an elastic body is disposed between the vibration plate 240 and the detecting portion 42, the vibration plate 240 and the detecting portion 42 may come into contact with each other due to the elastic body being compressed by striking the impact receiving surface 220a. In this case, the vibration sensor 41 may detect both the vibration caused by striking the impact receiving surface 220a and the vibration caused by the contact of the vibration plate 240. In other words, there is a possibility that the bass drum pad 12 generates sound twice in response to a single strike.

In this regard, with the bass drum pad 12 of the present embodiment, since the vibration plate 240 and the detecting portion 42 are bonded to each other, it is possible to prevent the vibration sensor 41 from detecting the vibration caused by the contact of the vibration plate 240.

### Advantages of the Present Embodiment

In addition to the advantages (1-1) to (1-4), (1-7) to (1-9), and (1-11) of the first embodiment, the bass drum pad 12 according to the present embodiment achieves the following advantages.
(3-1) The vibration plate 240 and the detecting portion 42 are bonded to each other.

This configuration achieves the above-described operation and thus prevents the bass drum pad 12 from generating sound twice in response to a single strike.
(3-2) The impact receiving unit 220 includes the restraining member 27, which has a lower flexibility than the vibration absorbing member 221.

With this configuration, the restraining member 27, which is fixed to the outer peripheral portion of the impact receiving surface 220a, has a lower flexibility than the vibration absorbing member 221. Therefore, when the impact receiving surface 220a is struck, deformation of the outer peripheral portion of the vibration absorbing member 221 is limited by the restraining member 27. Thus, the impact receiving unit 220 is prevented from becoming dislodged from the case 230 through the opening 236a of the cover 236.

In addition, according to the above-described configuration, both the vibration absorbing member 221 and the restraining member 27 have flexibility. Accordingly, by deforming the restraining member 27 together with the vibration absorbing member 221, the impact receiving unit 220 can be attached to and detached from the case 230 through the opening 236a of the cover 236.

### Fourth Embodiment

An electronic cymbal pad according to a fourth embodiment will now be described. In the present embodiment, the cymbal pad is used as the electronic cymbal pad 15, which forms part of an electronic drum set.

In the fourth embodiment, the same reference numerals are given to those components that are the same as those in the first embodiment. Also, reference numerals 3**, which are obtained by adding 300 to the reference numerals ** in the first embodiment, are given to the corresponding components, and redundant explanations are omitted.

The hi-hat cymbal pad 15a, the first cymbal pad 15b, and the second cymbal pad 15c shown in FIG. 1 have the same configuration. Hereinafter, the hi-hat cymbal pad 15a, the first cymbal pad 15b, and the second cymbal pad 15c are collectively referred to as cymbal pad 15.

### Overall Configuration of the Cymbal Pad 15

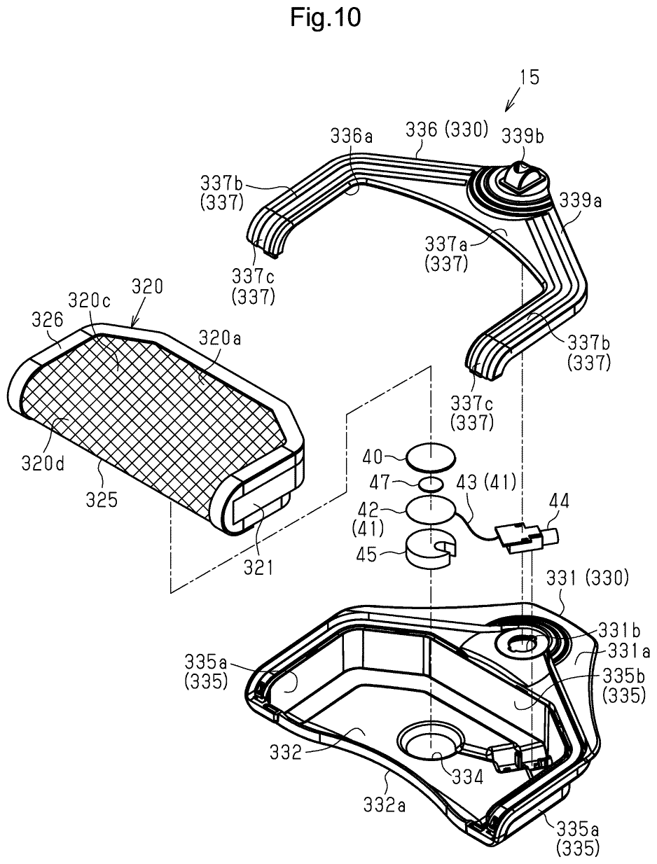

As shown in FIG. 10, the cymbal pad 15 includes an impact receiving unit 320, a case 330, a vibration plate 40, a vibration sensor 41, a first elastic member 45, and a second elastic member 47.

The impact receiving unit 320 has a rectangular shape having long sides and short sides in plan view. The cymbal pad 15 is disposed so as to face the player in the short-side direction of the impact receiving unit 320.

In the following description, a direction in which the long sides of the impact receiving unit 320 extend will simply be referred to as a long-side direction, and a direction in which the short sides extend will simply be referred to as a short-side direction. In addition, a direction away from the player in the short-side direction with reference to the cymbal pad 15 will be referred to as a forward direction, and a direction toward to the player in the short-side direction will be referred to as a rearward direction.

### Configuration of the Impact Receiving Unit 320

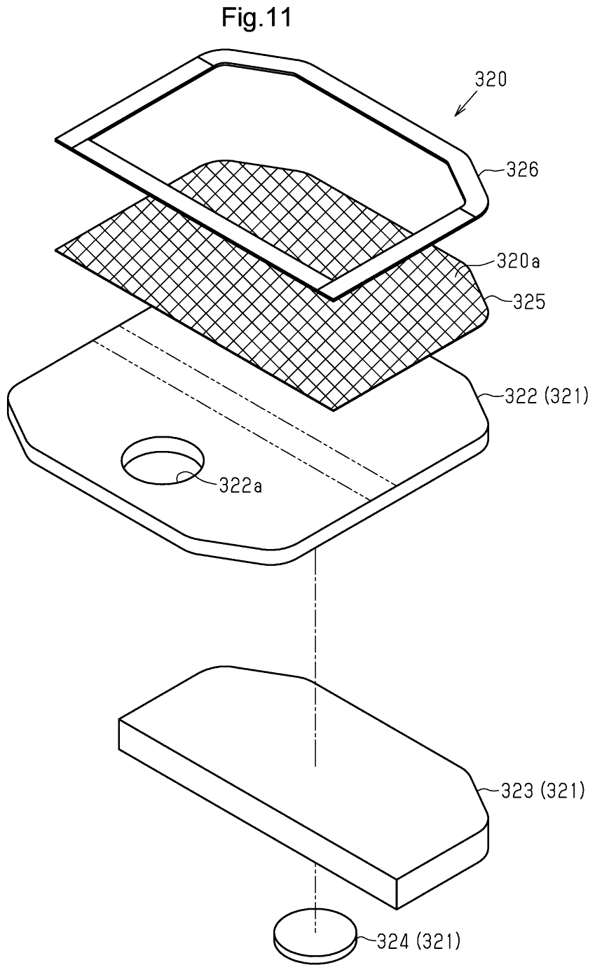

As shown in FIG. 11, the impact receiving unit 320 includes a vibration absorbing member 321, a sheet 325 covering the surface of the vibration absorbing member 321, and a cushioning member 326 covering the outer peripheral portion of the surface of the sheet 325.

The vibration absorbing member 321 includes a first sponge 322, a second sponge 323, and a third sponge 324. The first sponge 322 and the third sponge 324 are soft sponges. The second sponge 323 is a hard sponge.

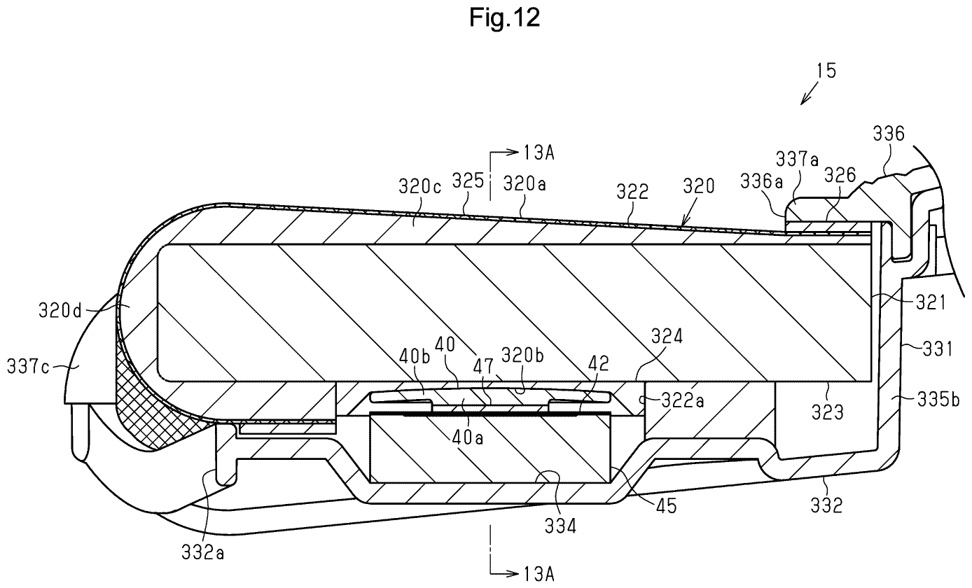

The second sponge 323 has the shape of a flat plate elongated in the long-side direction. The first sponge 322 is folded from the upper surface to the lower surface of the second sponge 323 so as to cover a rear end face of the second sponge 323, and is thereby formed into a U-shaped cross section (see FIG. 12). FIG. 11 shows the first sponge 322 before being folded. The first sponge 322 is folded at two locations indicated by the long-dash double-short-dash lines in FIG. 11. The first sponge 322 is bonded to the upper surface, the rear end face, and the lower surface of the second sponge 323 using an adhesive (not shown). A part of the first sponge 322 covering the lower surface of the second sponge 323 includes a circular center hole 322a extending through the first sponge 322 in the thickness direction. The third sponge 324 is disc-shaped. The diameter of the third sponge 324 is substantially the same as the diameter of the center holes 322a.

As shown in FIG. 12, the third sponge 324 is accommodated in the center hole 322a and is bonded to the lower surface of the second sponge 323 using an adhesive (not shown).

The sheet 325 is folded back from the upper surface to the lower surface of the first sponge 322 so as to cover the rear end face of the first sponge 322. The sheet 325 covers the entire upper surface and the entire rear end face of the first sponge 322. The sheet 325 covers a region of the lower surface of the first sponge 322 that is rearward of the center hole 322a.

In the impact receiving unit 320, a back surface 320b on a side opposite to the impact receiving surface 320a is formed by the first sponge 322, the third sponge 324, and the sheet 325.

An outer peripheral portion of the sheet 325 is bonded to the first sponge 322 using an adhesive (not shown).

As shown in FIG. 11, the cushioning member 326 has an annular shape having the same external dimensions as the external dimensions of the sheet 325. The cushioning member 326 is formed by arranging multiple elongated felt members in an annular shape. The cushioning member 326 is bonded to the outer peripheral portion of the surface of the sheet 325 using an adhesive (not shown). In other words, the vibration absorbing member 321, the sheet 325, and the cushioning member 326 are integrated. Similar to the sheet 325, the cushioning member 326 is folded from the upper surface to the lower surface of the first sponge 322.

As shown in FIG. 12, the impact receiving unit 320 includes a bow portion 320c, which forms the upper surface of the cymbal pad 15, and an edge portion 320d, which forms an outer peripheral portion continuous with the upper surface of the cymbal pad 15. The surfaces of the bow portion 320c and the edge portion 320d are formed by the sheet 325. The impact receiving surface 320a is formed by the surfaces of the bow portion 320c and the edge portion 320d.

### Structure of the Case 330

As shown in FIG. 10, the case 330 includes a case body 331 and a cover 336 attached to the case body 331. The case body 331 is formed of, for example, a hard resin material. The cover 336 is formed of, for example, a soft resin material. The cover 336 has flexibility.

The case body 331 includes a rectangular bottom wall 332, which is elongated in the long-side direction in plan view, and a case peripheral wall 335, which protrudes from the outer peripheral edge of the bottom wall 332.

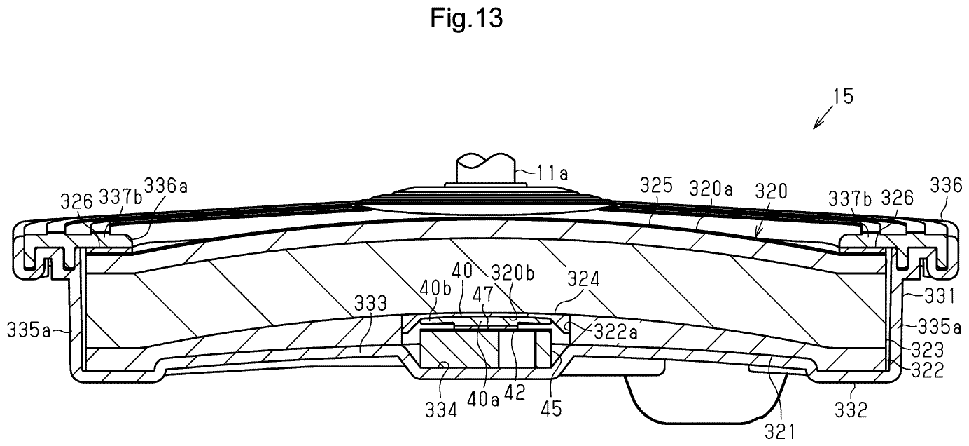

As shown in FIG. 13, the bottom wall 332 supports the back surface 320b of the impact receiving unit 320. The bottom wall 332 includes an arcuately curved portion 333 that is shaped such that its displacement increases toward a central region in the long-side direction. An accommodating recess 334 is provided in a central portion of the curved portion 333.

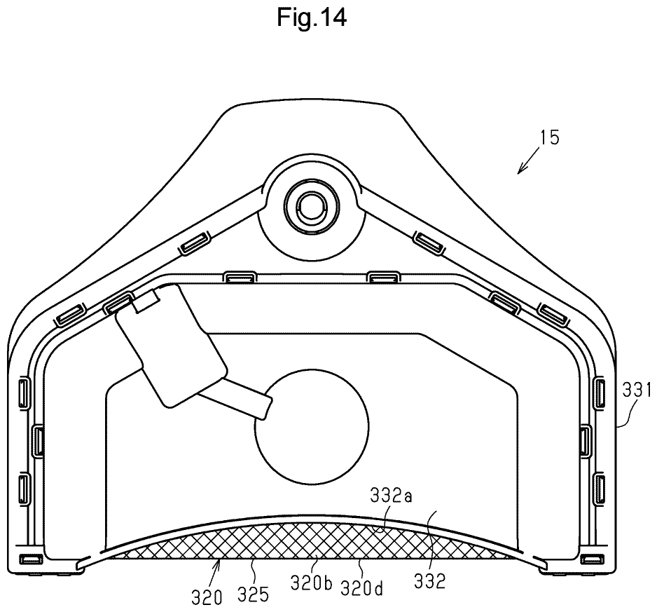

As shown in FIG. 14, the bottom wall 332 includes a cutout 332a that exposes a part of the back surface 320b of the impact receiving unit 320 that forms the edge portion 320d. The cutout 332a extends in the long-side direction at the rear edge of the bottom wall 332. The cutout 332a is curved such that its forward displacement increases toward a central region of the cutout 332a in the long-side direction. The part of the edge portion 320d exposed through the cutout 332a is covered by the sheet 325.

As shown in FIG. 10, the case peripheral wall 335 includes two facing portions 335a that face each other in the long-side direction, and a connecting portion 335b that connects the front ends of the facing portions 335a to each other. The case peripheral wall 335 has a U-shape opening rearward in plan view. Accordingly, the rear ends of the facing portions 335a are connected to each other only by the bottom wall 332.

The case body 331 includes a case flange portion 331a that protrudes forward from a protruding end of the connecting portion 335b. The width of the case flange portion 331a in the long-side direction decreases toward the front side. The case flange portion 331a includes a first insertion hole 331b into which the support rod 11b (see FIG. 1) attached to the stand 11 is inserted.

The cover 336 includes a retaining portion 337 that presses the impact receiving unit 320, and a cover flange portion 339a that covers the case flange portion 331a from above.

The retaining portion 337 includes a first part 337a extending in the long-side direction, two second parts 337b extending rearward from the opposite ends of the first part 337a, and two third parts 337c extending downward from the rear ends of the second parts 337b.

As shown in FIG. 12, the first part 337a covers the protruding end face of the connecting portion 335b and projects inward in the case body 331 beyond the connecting portion 335b. The first part 337a presses the front end of the impact receiving unit 320 from the side opposite to the bottom wall 332. The first part 337a presses the cushioning member 326.

As shown in FIG. 13, each second part 337b covers the protruding end face of the corresponding facing portion 335a and projects inward in the case body 331 beyond the facing portion 335a. The two second parts 337b press the opposite ends in the long-side direction of the impact receiving unit 320 from the side opposite to the bottom wall 332. The two second parts 337b press the cushioning member 326.

As shown in FIG. 10, each third part 337c covers the rear end face of the corresponding facing portion 335a and projects inward in the case body 331 beyond the facing portion 335a. The two third parts 337c press the opposite ends in the long-side direction of the rear end face of the impact receiving unit 320 from the side opposite to the connecting portion 335b. The two third parts 337c press the cushioning member 326.

As described above, the retaining portion 337 presses the bow portion 320c from above and presses the edge portion 320d from behind.

The retaining portion 337 forms an opening 336a that exposes the impact receiving surface 320a. The bow portion 320c and the edge portion 320d are exposed from the case 330 through the opening 336a.

The width of the cover flange portion 339a in the long-side direction decreases toward the front side. The cover flange portion 339a includes a second insertion hole 339b into which the support rod 11b (see FIG. 1) of the stand 11 is inserted. The cymbal pad 15 is supported by the support rod 11b inserted into the first insertion hole 331b and the second insertion hole 339b.

### Operation of the Present Embodiment

In an acoustic cymbal, a performance may involve striking an edge portion of the cymbal. For example, in the cymbal pad 15, if the edge portion 320d is covered by the case 330, the case 330 is struck when the edge portion 320d is struck. In this case, striking noise may be generated from the case 330.

In this regard, with the cymbal pad 15 according to the present embodiment, the bow portion 320c and the edge portion 320d of the impact receiving unit 320 are exposed from the case 330. Thus, since the case 330 is not struck when the bow portion 320c and the edge portion 320d are struck, the striking noise of the bow portion 320c and the edge portion 320d is reduced by the vibration absorbing member 321.

### Advantages of the Present Embodiment

In addition to the advantages (1-1) to (1-11) of the first embodiment, the cymbal pad 15 according to the present embodiment achieves the following advantage.
(4-1) The impact receiving unit 320 includes the bow portion 320c, which forms the upper surface of the cymbal pad 15, and the edge portion 320d, which forms the outer peripheral portion continuous with the upper surface of the cymbal pad 15. The bow portion 320c and the edge portion 320d are exposed from the case 330.

This configuration achieves the above-described operation and thus improves the noise suppression performance of the cymbal pad 15.
(4-2) The bottom wall 332 of the case 330 includes the cutout 332a, which exposes the part of the back surface 320b of the impact receiving unit 320 that forms the edge portion 320d.

With this configuration, the part of the back surface 320b of the impact receiving unit 320 that forms the edge portion 320d is exposed through the cutout 332a of the case 330. Therefore, when the player strikes the edge portion 320d with a drumstick, so that the edge portion 320d is deformed, the cutout 332a functions as a space that allows the drumstick to pass through. As a result, contact noise between the drumstick and the case 330 is reduced.
(4-3) The retaining portion 337 presses the bow portion 320c from above and presses the edge portion 320d from behind.

With this configuration, the impact receiving unit 320 is pressed from above and behind by the retaining portion 337. As a result, upward displacement of the impact receiving unit 320 within the case 330 is suppressed, thereby preventing a change in the relative position between the impact receiving unit 320 and the vibration plate 40. Therefore, it is possible to suppress reduction in the detection accuracy of the vibration sensor 41.

### Modifications

The above-described embodiments may be modified as follows. The above-described embodiments and the following modifications can be combined as long as the combined modifications remain technically consistent with each other.

The following modifications of the first embodiment can be similarly applied to the second to fourth embodiments.

In the first embodiment, the first sponge 22 is a hard sponge, and the second sponge 23 and the third sponge 24 are soft sponges. However, the combination thereof can be changed. For example, all of the first sponge 22, the second sponge 23, and the third sponge 24 may be soft sponges.

In the first embodiment, the vibration absorbing member 21 may be formed of an elastic material such as rubber instead of sponge.

In the first embodiment, the cover 36 may be bonded to the case 30.

In the first embodiment, the case 30 does not need to include the cover 36. For example, the case body 31 and the cover 36 of the case 30 may be integrally formed. In this case, the entire case 30 may have flexibility.

In the first embodiment, the impact receiving unit 20 does not need to be accommodated in the case 30 in a curved state. In other words, the impact receiving unit 20 may be accommodated in the case 30 in a state in which the impact receiving surface 20a is flat.

In the first embodiment, the entire sheet 25 may be bonded to the surface of the vibration absorbing member 21.

In the first embodiment, the sheet 25 does not need to be bonded to the surface of the vibration absorbing member 21. The sheet 25 may be provided on the surface of the vibration absorbing member 21 in a state in which tension is applied by the outer peripheral portion of the sheet 25 being sandwiched between the case body 31 and the cover 36.

In the first embodiment, the sheet 25 may be formed of a nonwoven fabric or a woven fabric made of natural fibers, chemical fibers, or the like.

In the first embodiment, the impact receiving unit 20 does not need to include the sheet 25. In this case, the impact receiving surface 20a is formed by the surface of the vibration absorbing member 21. That is, the vibration absorbing member 21 is exposed to the outside from the opening 36a of the cover 36.

In the first embodiment, the vibration plate 40 may be formed of a metal material.

In the first embodiment, the external dimensions of the second elastic member 47 may be larger than or equal to the external dimensions of the vibration plate 40.

In the first embodiment, the first elastic member 45 and the second elastic member 47 do not need to formed of a sponge as long as they are formed of an elastic material. Examples of such elastic materials include elastomers such as rubber, and springs.

In the first embodiment, the detecting portion 42 may have the shape of a polygonal plate.

In the first embodiment, the external dimensions of the vibration plate 40 may be larger or smaller than the external dimensions of the detecting portion 42.

In the first embodiment, the vibration plate 40 may be fixed to the back surface 20b of the impact receiving unit 20 so as not to be relatively movable.

In the first embodiment, the impact receiving unit 20 does not need to be accommodated in the case 30. For example, the impact receiving unit 20 may be supported by a flange protruding outward from an opening edge of a case having an opening. In this case, the vibration plate 40, the vibration sensor 41, the first elastic member 45, and the second elastic member 47 may be accommodated in the case.

In the first embodiment, the cushioning member 26 is not limited to being formed by felt members, and may be formed by an elastic material such as rubber members.

In the first embodiment, the base 40a may be omitted from the vibration plate 40.

In the first embodiment, the vibration sensor 41 may be disposed in a region on the outer side of the central portion of the impact receiving unit 20 inside the case 30.

In the first embodiment, the tom pad 14 may include multiple vibration sensors 41 disposed at different positions inside the case 30.

In the first embodiment, the tom pad 14 may include, in addition to the vibration sensor 41 disposed inside the case 30, a vibration sensor that is attached to the case 30 to detect vibration of the case 30.

In the first embodiment, the vibration sensor 41 does not need to be a piezoelectric element as long as it can detect vibration of the vibration plate 40.

In the third embodiment, the restraining member 27 may be divided in the circumferential direction.

In the third embodiment, the bass drum pad 12 does not need to include the restraining member 27. In this case, the cushioning member 26 may be bonded to the surface of the sheet 25.

In the fourth embodiment, the bottom wall 332 does not need to include the cutout 332a.

In the fourth embodiment, the first sponge 322 does not need to be folded back from the upper surface to the lower surface of the second sponge 323. For example, the first sponge 322 may cover only the upper surface of the second sponge 323.

In the fourth embodiment, the impact receiving unit 320 and the case 330 may have circular shapes in plan view. Even in this case, a part of the edge portion 320d may be exposed from the case 330.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A pad for an electronic percussion instrument, comprising:
an impact receiving unit including an impact receiving surface and a back surface opposite to the impact receiving surface, the back surface being formed of a vibration absorbing member that absorbs vibrations of the impact receiving surface;
a vibration plate that is in contact with the back surface and has external dimensions smaller than those of the back surface;
a case that supports the impact receiving unit and accommodates the vibration plate;
a vibration sensor that is disposed on a side opposite of the vibration plate from the impact receiving unit and detects vibrations of the vibration plate; and
an elastic member that presses the vibration sensor and the vibration plate toward the back surface.

2. The pad for an electronic percussion instrument according to claim 1, wherein the case accommodates the impact receiving unit in a state in which the impact receiving surface is exposed to an outside.

3. The pad for an electronic percussion instrument according to claim 1, wherein the vibration plate is in contact with the back surface without being fixed to the back surface.

4. The pad for an electronic percussion instrument according to claim 1, wherein
the vibration sensor includes a flat detecting portion that detects vibrations of the vibration plate, and
external dimensions of the vibration plate are larger than or equal to external dimensions of the detection unit.

5. The pad for an electronic percussion instrument according to claim 1, wherein
the elastic member is a first elastic member, and
the pad further comprises a second elastic member disposed between the vibration plate and the vibration sensor.

6. The pad for an electronic percussion instrument according to claim 5, wherein external dimensions of the second elastic member are smaller than the external dimensions of the vibration plate.

7. The pad for an electronic percussion instrument according to claim 1, wherein the vibration plate and the vibration sensor are bonded to each other.

8. The pad for an electronic percussion instrument according to claim 1, wherein the impact receiving unit includes a sheet that forms the impact receiving surface and covers a surface of the vibration absorbing member.

9. The pad for an electronic percussion instrument according to claim 8, wherein the sheet is a mesh material.

10. The pad for an electronic percussion instrument according to claim 8, wherein the vibration absorbing member and the sheet are integrated.

11. The pad for an electronic percussion instrument according to claim 8, wherein the impact receiving unit is accommodated in the case so as to be exposed to the outside in a state in which a central portion of the impact receiving surface is curved so as to protrude more than other portions.

12. The pad for an electronic percussion instrument according to claim 1, wherein
the case includes:
a case body that accommodates the impact receiving unit; and
a flexible cover that is attached to the case body, and
the cover includes a retaining portion that forms an opening for exposing the impact receiving surface and presses an outer peripheral portion of the impact receiving unit.

13. The pad for an electronic percussion instrument according to claim 12, wherein
the impact receiving unit includes a restraining member that is fixed to the outer peripheral portion of the impact receiving surface and pressed by the retaining portion, and
the restraining member has a lower flexibility than the vibration absorbing member.

14. The pad for an electronic percussion instrument according to claim 12, wherein an annular protrusion surrounding the opening is provided on a surface of the cover.

15. An electronic cymbal pad, comprising:
an impact receiving unit including an impact receiving surface and a back surface opposite to the impact receiving surface, the back surface being formed of a vibration absorbing member that absorbs vibrations of the impact receiving surface;
a case that accommodates the impact receiving unit in a state in which the impact receiving surface is exposed to an outside; and
a vibration sensor that detects vibrations of the impact receiving unit, wherein
the impact receiving unit includes:
a bow portion forming an upper surface of the electronic cymbal pad; and
an edge portion forming an outer peripheral portion continuous with the upper surface of the electronic cymbal pad, and
the bow portion and the edge portion are exposed from the case.

16. The electronic cymbal pad according to claim 15, wherein
the case includes a bottom wall that supports a back surface of the impact receiving unit opposite to the impact receiving surface, and
the bottom wall has a cutout that exposes a portion of the back surface that forms the edge portion of the back surface.
